(19) United States
(12) Patent Application Publication
(10) Pub. No.: US 2017/0154590 A1
(43) Pub. Date: Jun. 1, 2017

(54) GATE DRIVING CIRCUIT AND DISPLAY DEVICE INCLUDING THE SAME

(71) Applicant: Samsung Display Co., Ltd., Yongin-si (KR)

(72) Inventors: Sihyun Ahn, Asan-si (KR); Yanghee Kim, Busan (KR); Jaewon Kim, Asan-si (KR); Seungsoo Baek, Hwaseong-si (KR)

(21) Appl. No.: 15/229,798

(22) Filed: Aug. 5, 2016

(30) Foreign Application Priority Data
Dec. 1, 2015 (KR) 10-2015-0170157

(51) Int. Cl. G09G 3/36

(52) U.S. Cl. CPC G09G 3/3655; G09G 3/3659; G09G 2310/08; G09G 2300/043; G09G 2320/02

(57) ABSTRACT

A gate driving circuit includes a plurality of driving stages configured to output a plurality of gates signals, a k-th driving stage (where k is a natural number greater than 2) being configured to receive a clock signal, a (k−1)-th carry signal from a (k−1)-th driving stage, a (k+1)-th carry signal from a (k+1)-th driving stage, a (k+2)-th carry signal from a (k+2)-th driving stage, a first ground voltage, a second ground voltage, and a third ground voltage, and to output a k-th gate signal and a k-th carry signal, and wherein the k-th driving stage comprises a first pull-down circuit configured to discharge the k-th gate signal to the third ground voltage in response to the (k+1)-th carry signal, wherein the third ground voltage changes within a range during a single frame section in which the plurality of driving stages sequentially outputs the plurality of gate signals.

### CROSS-REFERENCE TO RELATED APPLICATIONS

This application claims priority to, and the benefit of, Korean Patent Application No. 10-2015-0170157, filed on Dec. 1, 2015, in the Korean Intellectual Property Office, the entire content of which is incorporated herein by reference.

### BACKGROUND

Aspects of the present disclosure herein relate to a gate driving circuit that is integrated into a display panel, and a display device that includes the gate driving circuit.

A display device includes a plurality of gate lines, a plurality of data lines, and a plurality of pixels that are connected to the plurality of gate lines and the plurality of data lines. The display device includes a gate driving circuit that provides gate signals to the plurality of gate lines, and a data driving circuit that outputs data signals to the plurality of data lines.

The gate driving circuit includes a shift register that includes a plurality of driving stage circuits (hereinafter, referred to as “driving stages”). The plurality of driving stages output corresponding gate signals to the plurality of gate lines. The plurality of driving stages includes a plurality of transistors that are closely connected.

In the case where the frequencies of gate signals that are output from the gate driving circuit are the same, a time available to charge each pixel decreases with an increase in resolution of a display panel. A decrease in available time to charge the pixel may cause a decrease in quality of a display image.

### SUMMARY

Aspects of the present disclosure are directed toward a gate driving circuit capable of enhancing the quality of an image.

Aspects of the present disclosure are also directed toward a display device that includes a gate driving circuit capable of enhancing the quality of an image.

According to some embodiments of the inventive concept, there is provided a gate driving circuit including: a plurality of driving stages configured to output a plurality of gates signals, a k-th driving stage (where k is a natural number greater than 2) of the plurality of driving stages being configured to receive a clock signal, a (k−1)-th carry signal from a (k−1)-th driving stage, a (k+1)-th carry signal from a (k+1)-th driving stage, a (k+2)-th carry signal from a (k+2)-th driving stage, a first ground voltage, a second ground voltage, and a third ground voltage, and to output a k-th gate signal and a k-th carry signal, and wherein the k-th driving stage comprises a first pull-down circuit configured to discharge the k-th gate signal to the third ground voltage in response to the (k+1)-th carry signal, wherein the third ground voltage changes within a range during a single frame section in which the plurality of driving stages sequentially outputs the plurality of gate signals.

In an embodiment, the third ground voltage gradually changes from an upper limit reference voltage to a lower limit reference voltage during the single frame section.

In an embodiment, the k-th driving stage of the plurality of driving stages further includes a second pull-down circuit configured to discharge the k-th carry signal to the second ground voltage in response to the (k+1)-th carry signal.

In an embodiment, the first pull-down circuit includes a first electrode connected to a carry terminal providing the k-th gate signal, a second electrode connected to a ground terminal providing the third ground voltage, and a control electrode connected to the (k+1)-th carry signal.

In an embodiment, the k-th driving stage of the plurality of driving stages further includes: a controller configured to provide one of the clock signal and the second ground voltage to a first node in response to the (k−1)-th carry signal and the (k+1)-th carry signal; and a first output circuit configured to output the clock signal to the k-th gate signal in response to a signal from the first node.

In an embodiment, the k-th driving stage of the plurality of driving stages further includes a second output circuit configured to output the clock signal to the k-th carry signal in response to the signal from the first node.

In an embodiment, the k-th driving stage of the plurality of driving stages further includes: an inverter configured to provide the clock signal to a second node; a first discharge circuit configured to discharge the first node to the second ground voltage in response to a signal from the second node, and to discharge the second node to the second ground voltage in response to the (k−1)-th carry signal; a second discharge circuit configured to discharge the k-th carry signal to the second ground voltage in response to the signal from the second node; and a third discharge circuit configured to discharge the k-th gate signal to the first ground voltage in response to the signal from the second node.

According to some embodiments of the inventive concept, there is provided a display device including: a display panel including a plurality of pixels connected to a plurality of gate lines and a plurality of data lines; a gate driving circuit including a plurality of driving stages is configured to output a plurality of gate signals to the plurality of gate lines; a data driving circuit configured to drive the plurality of data lines; and a driving controller configured to control the gate driving circuit and the data driving circuit in response to a control signal and an image signal that are externally provided, and to generate a first ground voltage, a second ground voltage, and a third ground voltage, wherein a k-th driving stage of the plurality driving stages (where k is a natural number greater than 2) is configured to receive a clock signal, a (k−1)-th carry signal from a (k−1)-th driving stage, a (k+1)-th carry signal from a (k+1)-th driving stage, a (k+2)-th carry signal from a (k+2)-th driving stage, the first ground voltage, the second ground voltage, and the third ground voltage, and to output a k-th gate signal and a k-th carry signal, and wherein the k-th driving stage includes a first pull-down circuit configured to discharge the k-th gate signal to the third ground voltage in response to the (k+1)-th carry signal, and wherein the driving controller is configured to alter a voltage level of the third ground voltage within a range during a single frame section in which the plurality of driving stages sequentially outputs the plurality of gate signals.

In an embodiment, the driving controller is configured to gradually alter the voltage level of the third ground voltage from a first reference voltage to a second reference voltage during the single frame section.

In an embodiment, the driving controller is configured to gradually lower the voltage level of the third ground voltage from an upper limit reference voltage to a lower limit reference voltage during the single frame section, when the gate signals are sequentially output in order from a driving stage nearest to the driving controller to a driving stage farthest from the driving controller.

In an embodiment, the driving controller is configured to gradually raise the voltage level of the third ground voltage from a lower limit reference voltage to an upper limit reference voltage during the single frame section, when the gate signals are sequentially output in order from a driving stage farthest from the driving controller to a driving stage nearest to the driving controller.

In an embodiment, the k-th driving stage of the plurality of driving stages further includes a second pull-down circuit configured to discharge the k-th carry signal to the second ground voltage in response to the (k+1)-th carry signal.

In an embodiment, the first pull-down circuit includes a first electrode connected to a carry terminal providing the k-th gate signal, a second electrode connected to a ground terminal providing the third ground voltage, and a control electrode connected to the (k+1)-th carry signal.

In an embodiment, the k-th driving stage of the plurality of driving stages further includes: a controller configured to provide one of the clock signal and the second ground voltage to a first node in response to the (k−1)-th carry signal and the (k+1)-th carry signal; and a first output circuit configured to output the clock signal to the k-th gate signal in response to a signal from the first node.

In an embodiment, the k-th driving stage of the plurality of driving stages further includes a second output circuit configured to output the clock signal to the k-th carry signal in response to the signal from the first node.

In an embodiment, the k-th driving stage of the plurality of driving stages further includes: an inverter configured to provide the clock signal to a second node; a first discharge circuit configured to discharge the first node to the second ground voltage in response to a signal from the second node, and to discharge the second node to the second ground voltage in response to the (k−1)-th carry signal; a second discharge circuit configured to discharge the k-th carry signal to the second ground voltage in response to the signal from the second node; and a third discharge circuit configured to discharge the k-th gate signal to the first ground voltage in response to the signal from the second node.

In an embodiment, the display panel includes: a display area in which the plurality of pixels are arranged; and a non-display area adjacent to the display area, wherein the gate driving circuit is integrated into the non-display area.

In an embodiment, a voltage level of the second ground voltage is lower than a voltage level of the first ground voltage.

In an embodiment, the driving controller is configured to gradually lower a voltage level of the third ground voltage, from the first reference voltage between the first ground voltage and the second ground voltage, to the second reference voltage lower than the second ground voltage during the single frame section.

### BRIEF DESCRIPTION OF THE FIGURES

The accompanying drawings are included to provide a further understanding of the inventive concept, and are incorporated in and constitute a part of this description. The drawings illustrate exemplary embodiments of the inventive concept and, together with the description, serve to explain principles of the inventive concept.

In the drawings:

FIG. 1 is a plane view of a display device according to an embodiment of the inventive concept;

FIG. 2 is a block diagram illustrating a configuration of a driving controller in FIG. 1;

FIG. 3 is a timing diagram of signals of a display device according to an embodiment of the inventive concept;

FIG. 4 is an equivalent circuit diagram of a pixel according to an embodiment of the inventive concept;

FIG. 5 is a cross-sectional view of a pixel according to an embodiment of the inventive concept;

FIG. 6 is a block diagram of a gate driving circuit according to an embodiment of the inventive concept;

FIG. 7 is a circuit diagram of a driving stage according to an embodiment of the inventive concept;

FIG. 8 is a timing diagram of the operations of driving stages;

FIG. 9 is a timing diagram of a third reference voltage according to another embodiment of the inventive concept; and

FIG. 10 is a timing diagram of a third reference voltage according to another embodiment of the inventive concept.

### DETAILED DESCRIPTION

Embodiments of the inventive concept are described below in detail with reference to the accompanying drawings.

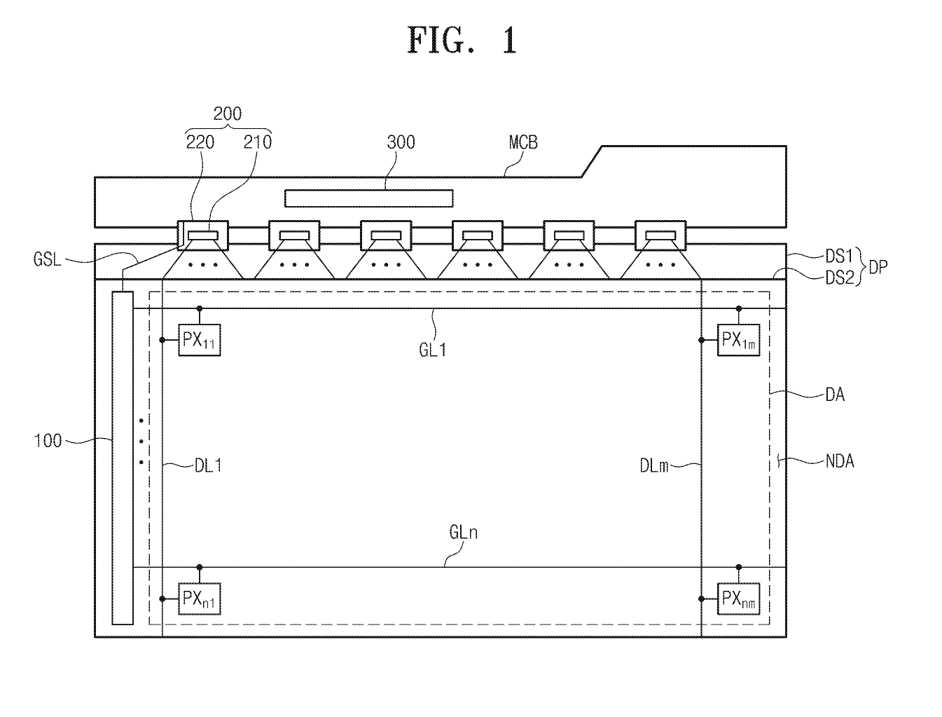

FIG. 1 is a plane view of a display device according to an embodiment of the inventive concept.

As shown in FIG. 1, the display device according to an embodiment of the inventive concept includes a display panel DP, a gate driving circuit 100, a data driving circuit 200, and a driving controller 300.

The display panel DP is not especially limited and may include various display panels, such as liquid crystal display panels, organic light emitting display panels, electrophoretic display panels, electrowetting display panels, and/or the like. In the present embodiment, the display panel DP is described as being a liquid crystal display panel. A liquid crystal display device that includes a liquid crystal display panel may further include a polarizer, a backlight, and/or the like.

The display panel DP includes a first substrate DS1, a second substrate DS2 spaced from the first substrate DS1, and a liquid crystal layer LCL that is disposed (e.g., located) between the first substrate DS1 and the second substrate DS2. When viewed from the plane view, the display panel DP includes a display area DA in which exist a plurality of pixels PX11 to PXnm, and a non-display area NDA that surrounds the display area DA. In some examples, the non-display area NDA may not include any pixels.

The display panel DP includes a plurality of gate lines GL1 to GLn that is disposed on the first substrate DS1, and a plurality of data lines that crosses the gate lines GL1 to GLn. The plurality of gate lines GL1 to GLn is connected to the gate driving circuit 100. The plurality of data lines DL1 to DLm is connected to the data driving circuit 200. For ease of illustration, FIG. 1 shows only some of the plurality of gate lines GL1 to GLn and some of the plurality of data lines DL1 to DLm.

FIG. 1 shows only some of the plurality of pixels PX11 to PXnm, for ease of illustartion. Each of the plurality of pixels PX11 to PXnm is connected to a corresponding one of the plurality of gate lines GL1 to GLn and to a corresponding one of the plurality of data lines DL1 to DLm.

The plurality of pixels PX11 to PXnm may be divided into a plurality of groups according to a color that each pixel represents. The plurality of pixels PX11 to PXnm may represent one of the primary colors. The primary colors may include red, green, blue, and white. However, the primary colors are not limited thereto and may further include various colors, such as yellow, cyan, magenta, etc.

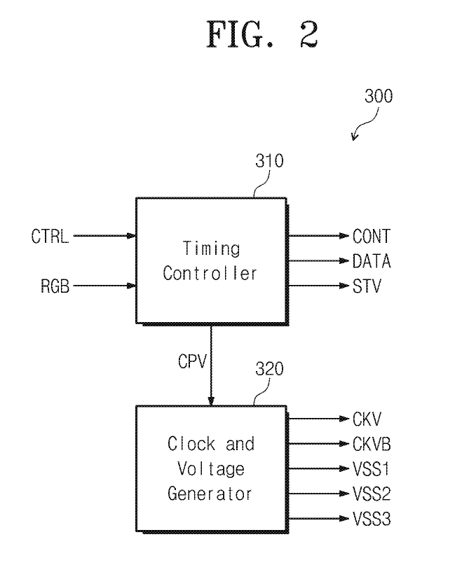

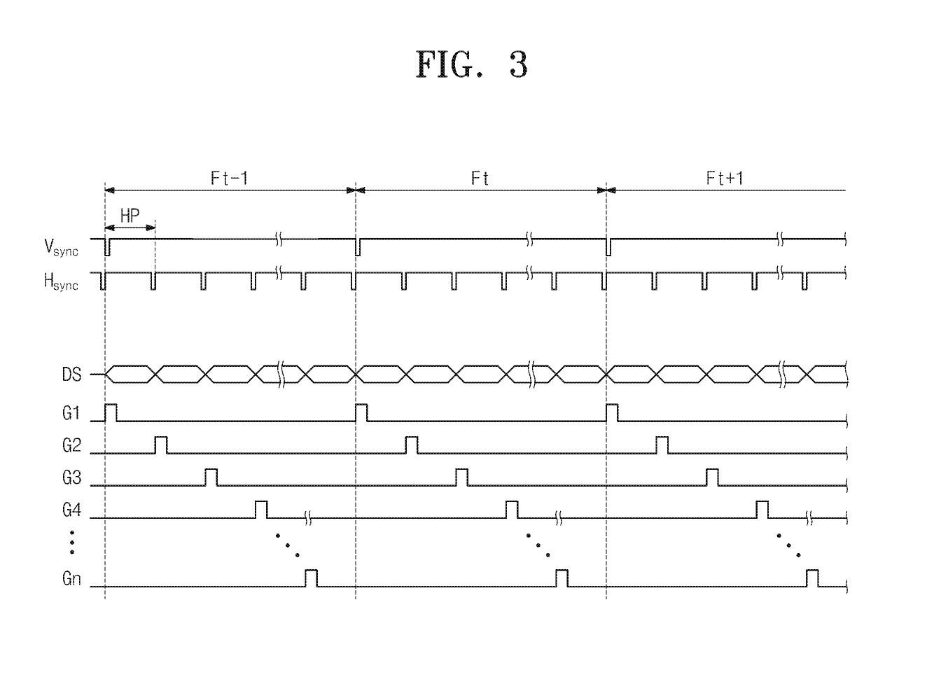

FIG. 2 is a block diagram illustrating a configuration of a driving controller in FIG. 1. FIG. 3 is a timing diagram of signals of a display device according to an embodiment of the inventive concept.

Referring to FIGS. 1 to 3, the driving controller 300 may be mounted on a main circuit board MCB. The driving controller 300 receives image data RGB and a control signal CTRL from an external graphic controller. The control signal CTRL may include a vertical synchronization signal Vsync that is a signal identifying frame sections Ft−1, Ft, and Ft+1, a signal identifying horizontal sections HP, that is, a horizontal synchronization signal Hsync, a data enable signal that is at a high level only during a frame section in which data is output in order to represent a zone which data enters, and clock signals.

The driving controller 300 includes a timing controller 310 and a clock and voltage generator 320. The timing controller 310 receives the image data RGB and the control signal CTRL, and outputs a data control signal CONT and a data signal DATA that are provided to the data driving circuit 200, a start signal STV to be provided to the gate driving circuit 100, and a gate pulse signal CPV to be provided to the clock and voltage generator 320.

The clock and voltage generator 320 receives the gate pulse signal CPV from the timing controller 310 and generates a first clock signal CKV, a second clock signal CKVB, a first ground voltage (e.g., a first low level reference voltage) VSS1, a second ground voltage (e.g., a second low level reference voltage) VSS2, and a third ground voltage (e.g., a third low level reference voltage) VSS3.

The first ground voltage VSS1, the second ground voltage VSS2, and the third ground voltage VSS3 that are generated by the clock and voltage generator 320 may have different voltage levels. The clock and voltage generator 320 may change the voltage level of the third ground voltage VSS3 within a certain range during a single frame section.

Referring back to FIG. 1, the gate driving circuit 100 and the data driving circuit 200 receive control signals from the driving controller 300.

The gate driving circuit 100 generates gate signals G1 to Gn based on a control signal (hereinafter, referred to as a “gate control signal”) that is received from the driving controller 300 through a signal line GSL for the frame sections Ft−1, Ft and Ft+1, and outputs the gate signals G1 to Gn to the plurality of gate lines GL1 to GLn.

The gate signals G1 to Gn may be sequentially output corresponding to the horizontal sections HP. The gate driving circuit 100 may be formed concurrently or simultaneously with the pixels PX11 to PXnm through a thin film process. For example, the gate driving circuit 100 may be mounted on the non-display area NDA as an oxide semiconductor thin film transistor (TFT) gate driver circuit (OSG).

FIG. 1 illustrates a single gate driving circuit 100 that is connected to the left ends of the plurality of gate lines GL1 to GLn; however, the present inventive concept is not limited thereto. For example, in the present embodiment of the inventive concept, the display device may include two gate driving circuits. One of the two gate driving circuits may be connected to the left ends of the plurality of gate lines GL1 to GLn and the other may be connected to the right ends of the plurality of gate lines GL1 to GLn. Also, one of the two gate driving circuits may be connected to odd-numbered gate lines and the other may be connected to even-numbered gate lines.

The data driving circuit 200 generates grayscale voltages according to image data that is provided from the driving controller 300, based on the control signal (hereinafter, referred to as the “data control signal”) received from the driving controller 300. The data driving circuit 200 outputs the grayscale voltages as data voltages DS to the plurality of data lines DL1 to DLm.

The data voltages DS may include positive data voltages having positive values and/or negative data voltages having negative values with respect to a common voltage. For each of the horizontal sections HP, some of the data voltages applied to the data lines DL1 to DLm may have positive polarity and the others may have negative polarity. The polarity of the data voltages DS may be reversed according to the frame sections Ft−1, Ft, and Ft+1 in order to reduce or prevent liquid crystal deterioration. The data driving circuit 200 may generate reversed data voltages in units of a frame section in response to a reversal signal.

The data driving circuit 200 may include a driving chip 210, and a flexible printed circuit board (FPCB) 220 on which the driving chip 210 is mounted. The data driving circuit 200 may include a plurality of driving chips 210 and an FPCB 220. The FPCB 220 electrically connects the main circuit board MCB and the first substrate DS1. The plurality of driving chips 210 provide data signals that correspond to corresponding ones of the plurality of data lines DL1 to DLm.

FIG. 1 illustrates a tape carrier package (TCP) type (kind) data driving circuit 200. In another embodiment of the inventive concept, the data driving circuit 200 may be disposed on the non-display area NDA of the first substrate DS1 in a chip-on-glass (COG) implementation.

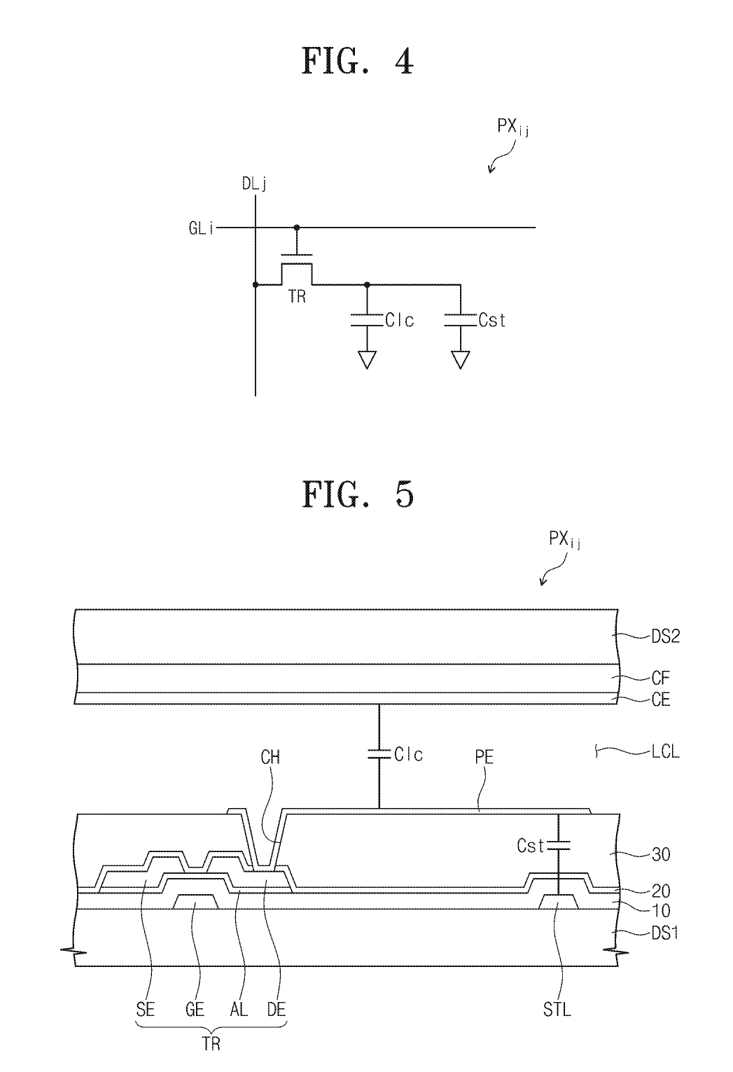

FIG. 4 is an equivalent circuit diagram of a pixel according to an embodiment of the inventive concept. FIG. 5 is a cross-sectional view of a pixel according to an embodiment of the inventive concept. Each of the plurality of pixels PX11 to PXnm in

FIG. 1 may have an equivalent circuit as illustrated in FIG. 4.

As shown in FIG. 4, a pixel PXij includes a pixel thin film transistor TR (hereinafter, referred to as a “pixel transistor”), a liquid crystal capacitor Clc, and a storage capacitor Cst. In the following, the transistor in the present disclosure refers to a thin film transistor. In an embodiment of the present disclosure, the storage capacitor Cst may be omitted.

The pixel transistor TR is electrically connected to an i-th gate line GLi and a j-th data line DLj. The pixel transistor TR outputs a pixel voltage that corresponding to the data signal received from the j-th data line DLj, in response to the gate signal received from the i-th gate line GLi.

The liquid crystal capacitor Clc charges a pixel voltage that is output from the pixel transistor TR. The arrangement of the liquid crystal director in a liquid crystal layer LCL (e.g., see FIG. 5) changes according to an amount of charge in the liquid crystal capacitor Clc. The light that enters the liquid crystal layer is transmitted or blocked according to the arrangement of the liquid crystal director.

The storage capacitor Cst is connected in parallel to the liquid crystal capacitor Clc. The storage capacitor Cst maintains the arrangement of the liquid crystal director during a certain frame section.

As shown in FIG. 5, the pixel transistor TR includes a control electrode GE that is connected to the i-th gate line GLi (e.g., see FIG. 4), an activation portion AL overlapped with the control electrode GE, a first electrode SE that is connected to the j-th data line DLj (e.g., see FIG. 4), and a second electrode DE that is disposed (e.g. located) apart from the first electrode SE.

The liquid crystal capacitor Clc includes a pixel electrode PE and a common electrode CE. The storage capacitor Cst includes the pixel electrode PE and a portion of a storage line STL overlapped with the pixel electrode PE.

The i-th gate line GLi and the storage line STL are disposed on a surface of the first substrate DS1. The control electrode GE is branched from the i-th gate line GLi. The i-th gate line GLi and the storage line STL may include metal, such as aluminum (Al), silver (Ag), copper (Cu), molybdenum (Mo), chrome (Cr), tantalum (Ta), titanium (Ti), and/or the like, and/or alloy(s) thereof. The i-th gate line GLi and the storage line STL may include a multi-layered structure, for example, a titanium layer and a copper layer.

A first insulating layer 10 that covers the control electrode GE and the storage line STL is disposed on a surface of the first substrate DS1. The first insulating layer 10 may include at least one of inorganic and organic materials. The first insulating layer 10 may be an organic film or an inorganic film. The first insulating layer 10 may include a multi-layered structure, for example, a silicon nitride layer and a silicon oxide layer.

The activation portion AL that is overlapped with the control electrode GE is disposed on the first insulating layer 10. The activation portion AL may include a semiconductor layer and an ohmic contact layer. The semiconductor layer is disposed on the first insulating layer 10, and the ohmic contact layer is disposed on the semiconductor layer.

A second electrode DE and a first electrode SE are disposed on the activation portion AL. The second electrode DE and the first electrode SE are disposed apart from each other. Each of the second electrode DE and the first electrode SE partially overlaps the control electrode GE.

A second insulating layer 20 that covers the activation portion AL, the second electrode DE and the first electrode SE is disposed on the first insulating layer 10. The second insulating layer 20 may include at least one of inorganic and organic materials. The second insulating layer 20 may be an organic film or an inorganic film. The second insulating layer 20 may include a multi-layered structure, for example, a silicon nitride layer and a silicon oxide layer.

Although FIG. 1 illustrates the pixel transistor TR that has a staggered structure, the structure of the pixel transistor TR is not limited thereto. For example, the pixel transistor TR may also have a planar structure.

A third insulating layer 30 is disposed on the second insulating layer 20. The third insulating layer 30 provides a planar surface. The third insulating layer 30 may include an organic material.

The pixel electrode PE is disposed on the third insulating layer 30. The pixel electrode PE is connected to the second electrode DE through a contact hole (e.g., contact opening) CH that passes through the second insulating layer 20 and the third insulating layer 30. An alignment film that covers the pixel electrode PE may be disposed on the third insulating layer 30.

A color filter layer CF is disposed on a surface of a second substrate DS2. A common electrode CE is disposed on the color filter layer CF. A common voltage is applied to the common electrode CE. A common voltage and a pixel voltage have different values. An alignment film that covers the common electrode CE may be disposed on the common electrode CE. Another insulating layer may be disposed between the color filter layer CF and the common electrode CE.

The pixel electrode PE and the common electrode CE, between which there is a liquid crystal layer LCL, form a liquid crystal capacitor Clc. Also, the pixel electrode

PE and the portion of the storage line STL between which there are a first insulating layer 10, a second insulating layer 20, and a third insulating layer 30 form a storage capacitor Cst. The storage line STL receives a storage voltage different from a pixel voltage. The storage voltage may have the same or substantially the same value as the common voltage.

The cross-sectional view of the pixel PXij shown in FIG. 5 is only an example.

Unlike the embodiment shown in FIG. 5, at least one of the color filter layer CF and the common electrode CE may be disposed on the first substrate DS1. That is, a liquid crystal display panel according to the present embodiment may include pixels that have a vertical alignment (VA) mode, a patterned vertical alignment (PVA) mode, an in-plane switching (IPS) or fringe-field switching (FFS) mode, a plane to line switching (PLS) mode, and/or the like.

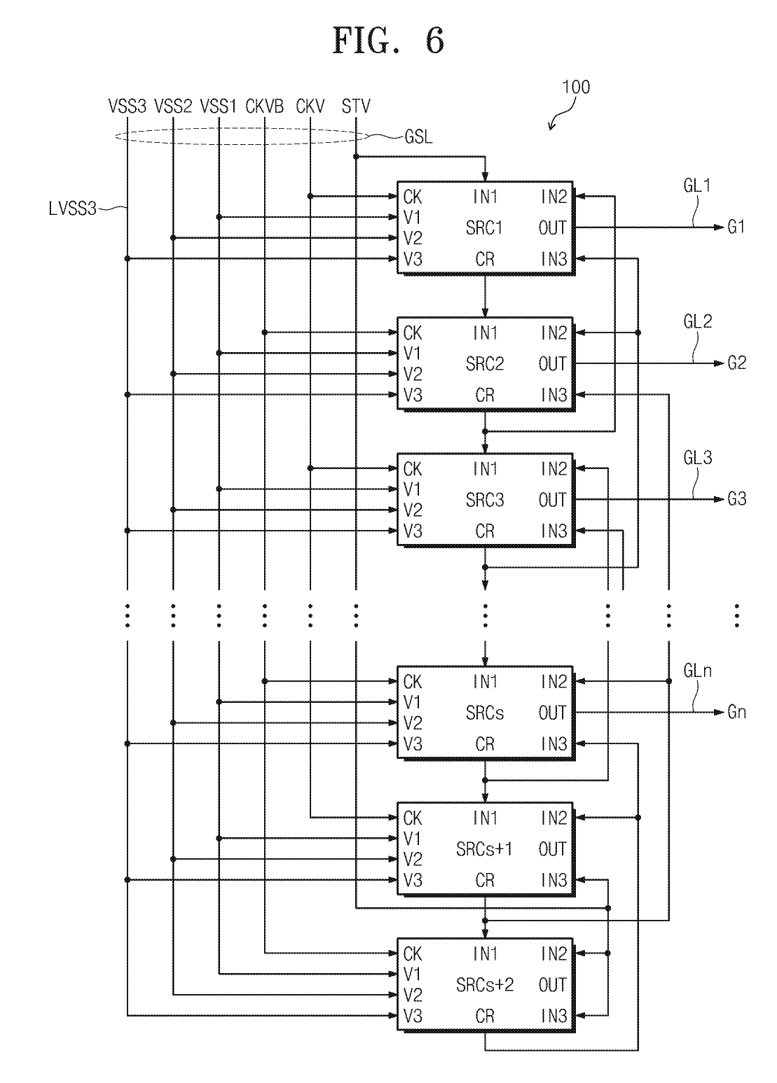

FIG. 6 is a block diagram of a gate driving circuit according to an embodiment of the inventive concept.

As shown in FIG. 6, a gate driving circuit 100 includes a plurality of driving stages SRC1 to SRCs and dummy driving stages SRCs+1 and SCRs+2. The plurality of driving stages SRC1 to SRCs and the dummy driving stages SRCs+1 and SCRs+2 have a dependent relation that operates in response to a carry signal output from the previous driving stage and a carry signal output from the next driving stage.

Each of the plurality of driving stages SRC1 to SRCs receives a first clock signal CKV/, a second clock signal CKVB, a first ground voltage VSS1, a second ground voltage VSS2, and a third ground voltage VSS3 from the driving controller 300 in FIG. 1. The driving stage SRC1 and the dummy driving stages SRCs+1 and SRCs+2 further receive a start signal STV.

In the present embodiment, the driving stages SRC1 to SRCs are connected to gate lines GL1 to GLn, respectively. The driving stages SRC1 to SRCs provides gate signals to the gate lines GL1 to GLn, respectively. In an embodiment of the inventive concept, the gate lines that are connected to the plurality of driving stages SRC1 to SRCs may be odd-numbered gate lines or even-numbered ones of the entire gate lines.

Each of the plurality of driving stages SRC1 to SRCs and the dummy driving stages SRCs+1 and SRCs+2 includes input terminals IN1, IN2, and IN3, an output terminal OUT, a carrier terminal CR, a control terminal CT, a clock terminal CK, a first ground terminal V1, a second ground terminal V2, and a third ground terminal V3.

The output terminal OUT of each of the plurality of driving stages SRC1 to SRCs is connected to a corresponding one of the plurality of gate lines GL1 to GLn. The gate signals that are generated from the plurality of driving stages SRC1 to SRCs are provided to the plurality of gate lines GL1 to GLn through the output terminal OUT.

The carry terminal CR of each of the plurality of driving stages SRC1 to SRCs is electrically connected to the first input terminal IN1 of the first driving stage after a corresponding driving stage. Also, the carry terminal CR of each of the plurality of driving stages SRC1 to SRCs is provided to the previous driving stages. For example, the carry terminal CR of the k-th one of the driving stages SRC1 to SRCs is connected to the second input terminal IN2 of the (k−1)-th driving stage and to the third input terminal IN3 of the k−2th driving stage. The carry terminal CR of each of the plurality of driving stages SRC1 to SRCs and the dummy driving stages SRCs+1 and SRCs+2 outputs a carry signal.

The first input terminal IN1 of each of the plurality of driving stages SRC2 to

SRCs and the dummy driving stages SRCs+1 and SRCs+2 receives the carry signal of a driving stage before a corresponding driving stage. For example, the input terminal IN of the k-th driving stages SRCk receives the carry signal of the (k−1)-th driving stage SRCk−1. The input terminal IN of the first SRC1 of the plurality of driving stages SRC1 to SRCs receives a vertical start signal STV that starts the driving of the gate driving circuit 100, instead of the carry signal of the previous driving stage.

The second input terminal IN2 of each of the plurality of driving stages SRC1 to SRCs receives the carry signal from the carry terminal CR of the first driving stage after a corresponding driving stage. The third input terminal IN3 of each of the plurality of driving stages SRC1 to SRCs receives a carry signal from the second driving stage after a corresponding driving stage. For example, the second input terminal IN2 of the k-th driving stage SRCk receives a carry signal that is output from the carry terminal CR of the (k+1)-th driving stage SRCk+1. The third input terminal IN3 of the k-th driving stage SRCk receives a carry signal that is output from the carry terminal CR of the (k+2)-th driving stage SRCk+2. In another embodiment of the inventive concept, the second input terminal IN2 of each of the plurality of driving stages SRC1 to SRCs may also be electrically connected to the output terminal OUT of the first driving stage after a corresponding driving stage. Also, the third input terminal IN3 of each of the plurality of driving stages SRC1 to SRCs may also be electrically connected to the output terminal OUT of the second driving stage after a corresponding driving stage.

The second input terminal IN2 of the last driving stage SRCs receives a carry signal that is output from the carry terminal CR of the dummy stage SRCs+1.

The third input terminal IN3 of the driving stage SRCs receives a carry signal that is output from the carry terminal CR of the dummy stage SRCs+2.

The clock terminal CK of each of the plurality of driving stages SRC1 to SRCs receives any one of the first and second clock signals CKV and CKVB. Each of the clock terminals CK of the odd-numbered ones SRC1, SRC3, SRCs−1 of the plurality of driving stages SRC1 to SRCs may receive the first clock signal CKV. Each of the clock terminals CK of the even-numbered ones SRC2, SRC4, SRCs of the plurality of driving stages SRC1 to SRCs may receive the second clock signal CKVB. The first clock signal CKV and the second clock signal CKVB may be out of phase (e.g., different in phase).

The first ground terminal V1 of each of the plurality of driving stages SRC1 to SRCs receives the first ground voltage VSS1. The second ground terminal V2 of each of the plurality of driving stages SRC1 to SRCs receives the second ground voltage VSS2. The third ground terminal V3 of each of the plurality of driving stages SRC1 to SRCs receives the third ground voltage VSS3. The first ground voltage VSS1 and the second ground voltage VSS2 have different voltage levels and the second ground voltage VSS2 has a lower voltage level than the first ground voltage VSS1. The third ground voltage VSS3 changes within a set or predetermined range for a frame section and repetitively changes each frame.

In an embodiment of the inventive concept, each of the plurality of driving stages SRC1 to SRCs may omit any one of the output terminal OUT, the input terminal IN, the carrier terminal CR, the control terminal CT, the clock terminal CK, the first ground terminal V1, the second ground terminal V2, and the third ground terminal V3, or further include other terminals, according to the circuit configuration of the driving stage. Also, the connection between the plurality of driving stages SRC1 to SRCs may also change.

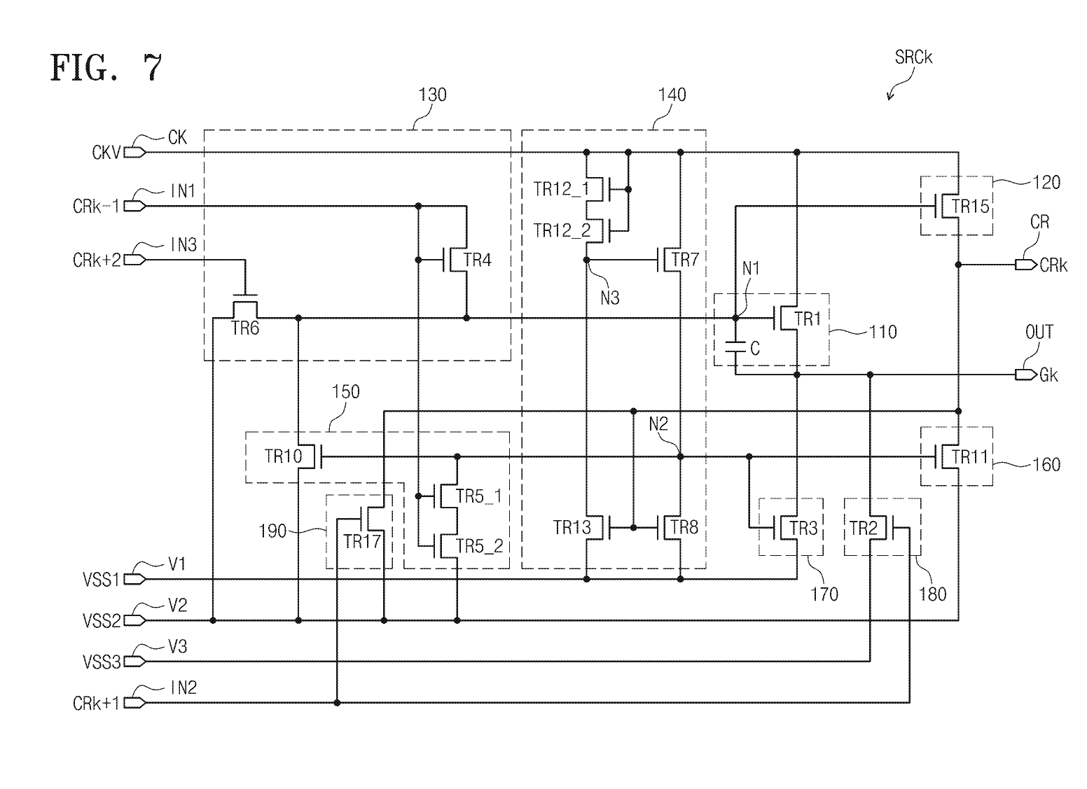

FIG. 7 is a circuit diagram of a driving stage according to an embodiment of the inventive concept.

FIG. 7 illustrates a k-th driving stage SRCk (where k is a positive integer) of the plurality of driving stages SRC1 to SRCs in FIG. 6. Each of the plurality of driving stages SRC1 to SRCs in FIG. 6 may have the same or substantially the same circuit as the k-th driving stage.

Referring to FIG. 7, the k-th driving stage SRCk includes a first output unit (e.g., a first output circuit or transistor) 110, a second output unit (e.g., a second output circuit or transistor) 120, a control unit (e.g. a controller) 130, an inverter unit (e.g. an inverter) 140, a first discharge unit (e.g., a first discharge circuit) 150, a second discharge unit (e.g., a second discharge circuit or transistor) 160, a third discharge unit (e.g., a third discharge circuit) 170, a first pull-down unit (e.g., a first pull-down circuit or transistor) 180, and a second pull-down unit (e.g., a second pull-down circuit or transistor) 190.

The first output unit 110 outputs a k-th gate signal Gk and the second output unit 120 outputs a k-th carry signal CRk. The first pull-down unit 180 pulls the output terminal OUT down to the first ground voltage VSS3 that is connected to the third ground terminal V3. The second pull-down unit 190 pulls the carry terminal CR down to the second ground voltage VSS2 that is connected to the second ground terminal V2. The control unit 130 controls the operations of the first output unit 110 and the second output unit 120 in response to the (k−1)-th carry signal CRk-1 that is received by the first input terminal IN from the previous driving stage SRCk-1.

The detailed configuration of the k-th driving stage SRCk is as follows.

The first output unit 110 includes a first output transistor TR1 and a capacitor C. The first output transistor TR1 includes a first electrode that is connected to the clock terminal CK, a control electrode that is connected to a first node N1, and a second electrode that outputs the k-th gate signal Gk.

The second output unit 120 includes a second output transistor TR15. The second output transistor TR15 includes a first electrode that is connected to the clock terminal CK, a control electrode that is connected to the first node N1, and a second electrode that outputs a k-th carry signal CRk.

As shown in FIG. 6, the clock terminals CK of some SRC1, SRC3, SRCs−1 of the driving stages SRC1 to SRCs and the dummy driving stage SRCs+1 receive the first clock signal CKV. The clock terminals CK of the others SRC2, SRC4, SRCs of the driving stages SRC1 to SRCs and the dummy driving stage SRCs+2 receive a second clock signal CKVB. The clock signal CKV and the clock signal CKVB are complementary signals (e.g., are inverses of one another). That is, the first clock signal CKV and the second clock signal CKVB may have a phase difference of about 180°.

The control unit 130 turns on the first output transistor TR1 and a second output transistor TR2 in response to the (k−1)-th carry signal CRk−1 that is received by the first input terminal IN1 from the previous driving stage SRCk−1. The control unit 130 turns off the first output transistor TR1 and a second output transistor TR2 in response to a (k+1)-th carry signal CRk+2 that is received by the third input terminal IN3 from the next driving stage SRCk+2.

The control unit 130 includes fourth and sixth transistors TR4 and TR6. The fourth transistor TR4 includes a first electrode that is connected to the first input terminal IN1, a second electrode that is connected to the first node N1, and a control electrode that is connected to the first input terminal IN1. The sixth transistor TR6 includes a first electrode that is connected to the first node N1, a second electrode that is connected to the second ground terminal V2, and a control electrode that is connected to the third input terminal IN3.

The inverter unit 140 delivers the clock signal CKV from the clock terminal CK to a second node N2. The inverter unit 140 includes transistors TR7_1, TR7_1, TR8, TR12, and TR13. The seventh transistor TR7 includes a first electrode that is connected to the clock terminal CK, a second electrode that is connected to the second node N2, and a control electrode that is connected to a third node N3. Twelfth transistors TR12_1 and TR12_2 are connected in series between the clock terminal CK and the third node N3. The first electrode of the twelfth transistor TR12_1 is connected to the clock terminal CK. The second electrode of the twelfth transistor TR12_2 is connected to the third node N3. The second electrode of the twelfth transistor TR12_1 and the first electrode of the twelfth transistor TR12_2 are connected to each other. The control electrodes of the twelfth transistors TR12_1 and TR12_2 are connected to the clock terminal CK in common. The eighth transistor TR8 includes a first electrode that is connected to the second node N2, a second electrode that is connected to the first ground terminal V1, and a control electrode that is connected to a carry terminal CR. The thirteenth transistor TR13 includes a first electrode that is connected to the third node N3, a second electrode that is connected to the first ground terminal V1, and a control electrode that is connected to the carry terminal CR.

The first discharge unit 150 discharges the second node N2 to the second ground terminal V2 (e.g., lowers the voltage level of the second node N2 to that of the second ground terminal V2) in response to the previous carry signal CRk−1 and discharges the first node N1 to the second ground terminal V2 in response to a signal from the second node N2. The first discharge unit 150 includes fifth transistors TR5_1 and TR5_2 and a tenth transistor TR10.

The fifth transistors TR5_1 and TR5_2 are sequentially connected in series between the second node N2 and the second ground terminal V2. The fifth transistor TR5_1 includes a first electrode that is connected to the second node N2, a second electrode, and a control electrode that is connected to the first input terminal IN1 that receives the (k−1)-th carry signal CRk−1. The fifth transistor TR5_2 includes a first electrode, a second electrode that is connected to the second ground terminal V2, and a control electrode that is connected to the first input terminal IN1 that receives the previous carry signal CRk−1. The second electrode of the fifth transistor TR5_1 and the first electrode of the fifth transistor TR5_2 are connected to each other. The tenth transistor TR10 includes a first electrode that is connected to the first node N1, a second electrode that is connected to the second ground terminal V2, and a control electrode that is connected to the second node N2.

The second discharge unit 160 discharges the carry terminal CR to the second ground terminal V2 (e.g., lowers the voltage level of the carry terminal CR to that of the second ground terminal V2) in response to a signal from the second node N2. The second discharge unit 160 includes an eleventh transistor TR11 that includes a first electrode connected to the carry terminal CR, a second electrode connected to the second ground terminal V2, and a control electrode connected to the second node N2.

The third discharge unit 170 discharges the output terminal OUT to the first ground terminal V1 in response to a signal from the second node N2. The third discharge unit 170 includes a third transistor TR3 that includes a first electrode connected to the output terminal OUT, a second electrode connected to the first ground terminal V1, and a control electrode connected to the second node N2.

The first pull-down unit 180 discharges the output terminal OUT to the third ground terminal V3 in response to the (k+1)-th carry signal CRk+1 that is received through a second input terminal IN2. The first pull-down unit 180 includes a second transistor TR3 that includes a first electrode connected to the output terminal OUT, a second electrode connected to the third ground terminal V3, and a control electrode connected to the second input terminal IN2.

The second pull-down unit 190 discharges the carry terminal CR to the second ground terminal V2 in response to the (k+1)-th carry signal CRk+1 that is received through the second input terminal IN2. The second pull-down unit 190 includes a seventeenth transistor TR17 that includes a first electrode connected to the carry terminal CR, a second electrode connected to the second ground terminal V2, and a control electrode connected to the second input terminal IN2.

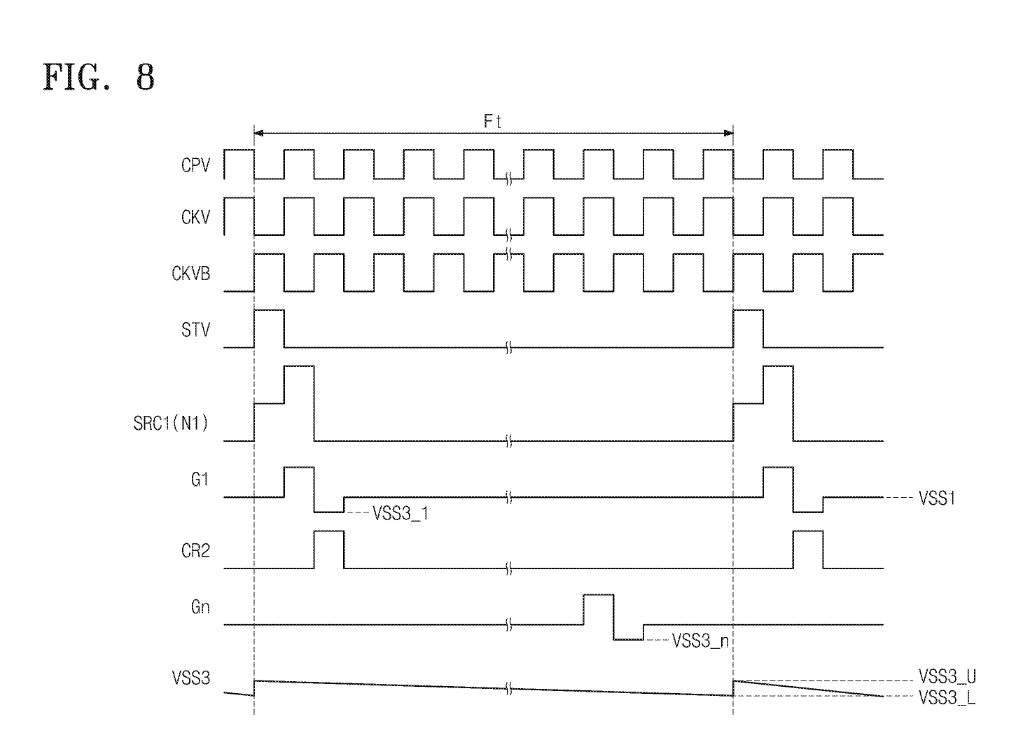

FIG. 8 is a timing diagram of the operations of driving stages.

Referring to FIGS. 7 and 8, a first clock signal CKV and a second clock signal CKVB have the same frequency and different phases.

When a start signal STV shifts (e.g., changes) to the high level, a transistor TR4 is turned on and the voltage level of a first node N1 increases. When the first clock signal CKV shifts to the high level, a first output transistor TR1 is turned on and the voltage of a first node N1 in a stage SRC1 is boosted by a capacitor C. In this case, a first gate signal G1 is output through an output terminal OUT. When a second output transistor TR2 is turned on by the boosted voltage of the first node N1 in the stage SRC1, a first carry signal CR1 is output through a carry terminal CR.

Subsequently, when a second carry signal CR2 shifts to the high level, a second transistor T2 in a first pull-down unit 180 is turned on and the first gate signal G1 of the output terminal OUT is discharged to (e.g., has it's voltage level lowered to a level of) a third ground voltage VSS3. When a seventeenth transistor TR17 in a second pull-down unit 190 is turned on in response to a high level of a second carry signal CR2, the first carry signal CR1 of the carry terminal CR is discharged to a second ground voltage VSS2.

In the present embodiment, the second ground voltage VSS2 has a voltage level lower than the first ground voltage VSS1 (i.e., VSS1>VSS2). A third ground voltage VSS3 has a lower voltage level than the first ground voltage VSS1 and may change within a set or predetermined range for a frame section Ft. For example, the third ground voltage VSS3 may gradually change (e.g., linearly change or change in a stepwise manner) from an upper limit reference voltage VSS3_U to a lower limit reference voltage VSS_L for a frame section. As an example, the first ground voltage VSS is about −7.5 V, and the second ground voltage VSS2 is about −11.5 V. The upper limit reference voltage VSS_U of the third ground voltage VSS3 is about −10.5 V and the lower limit reference voltage VSS3_L thereof is about −15.0 V.

Because the first gate signal G1 is discharged to the third ground voltage VSS3 that is a lower voltage level than the first ground voltage VSS1, the discharge speed of the first gate signal G1 (e.g., the speed at which the voltage of the first gate signal G1 is lowered) may be enhanced.

The clock and voltage generator 320 in FIG. 2 may count the gate pulse signal CPV received from the timing controller 310 to know the start and end of the frame section Ft. When the frame section Ft starts, the clock and voltage generator 320 generates the third ground voltage VSS3 that is at a level of the upper limit reference voltage VSS3_U. The clock and voltage generator 320 gradually lowers the voltage level of the third ground voltage VSS3 with an increase in the count value of the gate pulse signal CPV.

As shown in FIGS. 1 and 6, the voltage level of the third ground voltage

VSS3 (that is provided to the stage SRCs farthest from the driving controller 300) rises above the voltage level of the third ground voltage VSS3 (that is provided to a stage SRC1 nearest to the driving controller 300), due to the delay and voltage loss of a third ground voltage signal line LVSS3 to which the third ground voltage VSS3 is transmitted. For example, when the voltage level of the third ground voltage VSS3 that is generated from the driving controller 300 is about −11.5 V, the voltage level of the third ground voltage VSS3 that is provided to the stage SRCs may change to about −9.8 V. In this case, the discharge speed of the gate signals G1 to Gn may change, and as a result, an amount of charge of pixels PX11 to PXnm may change.

As shown in FIG. 8, the driving controller 300 generates the third ground voltage VSS3 so that the voltage level of the third ground voltage VSS3 when the stage SRCs farthest from the driving controller 300 operates is lower than that of the third ground voltage VSS3 when the nearest stage SRC1 operates.

Therefore, the discharge voltage level of the first gate signal G1, when the first gate signal G1 is discharged to the third ground voltage VSS3 by a second transistor TR2, becomes the same as the discharge voltage level VSS_n of the nth gate signal Gn when the nth gate signal Gn is discharged to the third ground voltage VSS3 (VSS_1 =VSS_n). That is, because the driving controller 300 generates the third ground voltage VSS3 in consideration of the voltage fluctuation of the third ground voltage signal line LVSS3, the discharge voltage level of the gate signals G1 to Gn may be substantially the same.

When the resolution of the display panel DP in FIG. 1 increases, an available horizontal period cycle (e.g., 1 H cycle) decreases and thus an available time to charge each pixel decreases. When the discharge speed of the gate signals G1 to Gn increases, it is desirable to gain pixel charging time. Also, when the discharge speeds of the gate signals G1 to Gn are uniform, the pixel charging time is uniform, and thus it is possible to decrease a deviation in charging rate according to the position of a pixel.

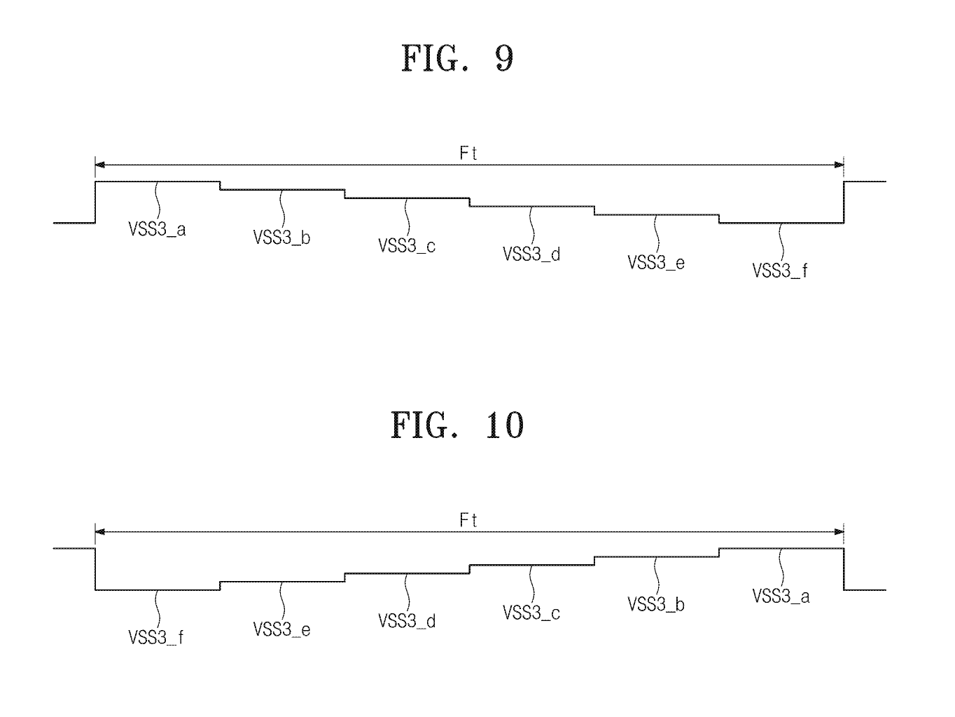

FIG. 9 is a timing diagram of a third ground voltage according to another embodiment of the inventive concept.

Referring to FIGS. 2, 6 and 9, when the gate signals G1 to Gn are sequentially output in order from the stage SRC1 nearest to the driving controller 300 to the stage SRCs farthest therefrom, the clock and voltage generator 320 may generate the third ground voltage VSS3 that gradually changes (e.g., decrements in a step-wise manner) during a single frame section Ft. The clock and voltage generator 320 generates the third ground voltage VSS3, gradually lowering a voltage level from the upper limit reference voltage VSS3_a to the lower limit reference voltage VSS3_f.

FIG. 10 is a timing diagram of a third ground voltage according to another embodiment of the inventive concept.

Referring to FIGS. 2, 6, and 10, when the gate signals G1 to Gn are sequentially output in order of distance from the stage SRCs farthest from the driving controller 300 to the stage SRC1 nearest thereto, the clock and voltage generator 320 may generate the third ground voltage VSS3 that gradually changes (e.g., incrementally changes in a stepwise manner) during a single frame section Ft. The clock and voltage generator 320 generates the third ground voltage VSS3, gradually raising (e.g., incrementally increasing) a voltage level from the lower limit reference voltage VSS3_f to the upper limit reference voltage VSS3_a.

In view of foregoing, a gate driving circuit that has a configuration according to one or more embodiments of the present disclosure may discharge the gate signal to the third ground voltage lower than the first ground voltage to enhance the discharge speed of the gate signal. It is possible to gain pixel charging time with a decrease in delay of the gate signal. In order to compensate for voltage fluctuation according to the delay in a third ground voltage signal line when the third ground voltage is provided to the plurality of stages in the gate driving circuit, it is possible to alter the voltage level of the third ground voltage for a single frame to decrease a deviation in charging rate according to the position of the pixel. Thus, the display quality of the display device may be enhanced.

It will be understood that, although the terms “first”, “second”, “third”, etc., may be used herein to describe various elements, components, regions, layers and/or sections, these elements, components, regions, layers and/or sections should not be limited by these terms. These terms are used to distinguish one element, component, region, layer or section from another element, component, region, layer or section. Thus, a first element, component, region, layer or section discussed below could be termed a second element, component, region, layer or section, without departing from the spirit and scope of the inventive concept.

It will also be understood that when a layer is referred to as being “between” two elements, it can be the only element between the two elements, or one or more intervening elements may also be present.

The terminology used herein is for the purpose of describing particular embodiments and is not intended to be limiting of the inventive concept. As used herein, the singular forms “a” and “an” are intended to include the plural forms as well, unless the context clearly indicates otherwise. It will be further understood that the terms “include,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Expressions such as “at least one of,” when preceding a list of elements, modify the entire list of elements and do not modify the individual elements of the list. Further, the use of “may” when describing embodiments of the inventive concept refers to “one or more embodiments of the inventive concept.” Also, the term “exemplary” is intended to refer to an example or illustration.

It will be understood that when an element or layer is referred to as being “on”, “connected to”, “coupled to”, or “adjacent” another element or layer, it can be directly on, connected to, coupled to, or adjacent the other element or layer, or one or more intervening elements or layers may be present. When an element or layer is referred to as being “directly on,” “directly connected to”, “directly coupled to”, or “immediately adjacent” another element or layer, there are no intervening elements or layers present.

As used herein, the term “substantially,” “about,” and similar terms are used as terms of approximation and not as terms of degree, and are intended to account for the inherent variations in measured or calculated values that would be recognized by those of ordinary skill in the art.

The gate driving circuit and/or any other relevant devices or components according to embodiments of the present invention described herein may be implemented utilizing any suitable hardware, firmware (e.g. an application-specific integrated circuit), software, or a suitable combination of software, firmware, and hardware. For example, the various components of the gate driving circuit may be formed on one integrated circuit (IC) chip or on separate IC chips. Further, the various components of the gate driving circuit may be implemented on a flexible printed circuit film, a tape carrier package (TCP), a printed circuit board (PCB), or formed on a same substrate. Further, the various components of the gate driving circuit may be a process or thread, running on one or more processors, in one or more computing devices, executing computer program instructions and interacting with other system components for performing the various functionalities described herein. The computer program instructions are stored in a memory which may be implemented in a computing device using a standard memory device, such as, for example, a random access memory (RAM). The computer program instructions may also be stored in other non-transitory computer readable media such as, for example, a CD-ROM, flash drive, or the like. Also, a person of skill in the art should recognize that the functionality of various computing devices may be combined or integrated into a single computing device, or the functionality of a particular computing device may be distributed across one or more other computing devices without departing from the scope of the exemplary embodiments of the present invention.

While embodiments are described above, a person skilled in the art may understand that many suitable modifications and variations may be implemented without departing from the spirit and scope of the inventive concept, as defined by the following claims and equivalents thereof. Also, embodiments disclosed in the present disclosure are not intended to limit the technical spirit of the inventive concept and the following claims and all technical spirits falling within equivalent scope are construed as being included in the scope of rights of the inventive concept.

What is claimed is:

1. A gate driving circuit comprising:
a plurality of driving stages configured to output a plurality of gates signals, a k-th driving stage (where k is a natural number greater than 2) of the plurality of driving stages being configured to receive a clock signal, a (k−1)-th carry signal from a (k−1)-th driving stage, a (k+1)-th carry signal from a (k+1)-th driving stage, a (k+2)-th carry signal from a (k+2)-th driving stage, a first ground voltage, a second ground voltage, and a third ground voltage, and to output a k-th gate signal and a k-th carry signal, and
wherein the k-th driving stage comprises a first pull-down circuit configured to discharge the k-th gate signal to the third ground voltage in response to the (k+1)-th carry signal,
wherein the third ground voltage changes within a range during a single frame section in which the plurality of driving stages sequentially outputs the plurality of gate signals.

2. The gate driving circuit of claim 1, wherein the third ground voltage gradually changes from an upper limit reference voltage to a lower limit reference voltage during the single frame section.

3. The gate driving circuit of claim 1, wherein the k-th driving stage of the plurality of driving stages further comprises a second pull-down circuit configured to discharge the k-th carry signal to the second ground voltage in response to the (k+1)-th carry signal.

4. The gate driving circuit of claim 2, wherein the first pull-down circuit comprises a first electrode connected to a carry terminal providing the k-th gate signal, a second electrode connected to a ground terminal providing the third ground voltage, and a control electrode connected to the (k+1)-th carry signal.

5. The gate driving circuit of claim 1, wherein the k-th driving stage of the plurality of driving stages further comprises:
a controller configured to provide one of the clock signal and the second ground voltage to a first node in response to the (k−1)-th carry signal and the (k+1)-th carry signal; and
a first output circuit configured to output the clock signal to the k-th gate signal in response to a signal from the first node.

6. The gate driving circuit of claim 5, wherein the k-th driving stage of the plurality of driving stages further comprises a second output circuit configured to output the clock signal to the k-th carry signal in response to the signal from the first node.

7. The gate driving circuit of claim 5, wherein the k-th driving stage of the plurality of driving stages further comprises:
an inverter configured to provide the clock signal to a second node;
a first discharge circuit configured to discharge the first node to the second ground voltage in response to a signal from the second node, and to discharge the second node to the second ground voltage in response to the (k−1)-th carry signal;
a second discharge circuit configured to discharge the k-th carry signal to the second ground voltage in response to the signal from the second node; and
a third discharge circuit configured to discharge the k-th gate signal to the first ground voltage in response to the signal from the second node.

8. A display device comprising:
a display panel comprising a plurality of pixels connected to a plurality of gate lines and a plurality of data lines;
a gate driving circuit comprising a plurality of driving stages is configured to output a plurality of gate signals to the plurality of gate lines;
a data driving circuit configured to drive the plurality of data lines; and
a driving controller configured to control the gate driving circuit and the data driving circuit in response to a control signal and an image signal that are externally provided, and to generate a first ground voltage, a second ground voltage, and a third ground voltage,
wherein a k-th driving stage of the plurality driving stages (where k is a natural number greater than 2) is configured to receive a clock signal, a (k−1)-th carry signal from a (k−1)-th driving stage, a (k+1)-th carry signal from a (k+1)-th driving stage, a (k+2)-th carry signal from a (k+2)-th driving stage, the first ground voltage, the second ground voltage, and the third ground voltage, and to output a k-th gate signal and a k-th carry signal, and
wherein the k-th driving stage comprises a first pull-down circuit configured to discharge the k-th gate signal to the third ground voltage in response to the (k+1)-th carry signal, and
wherein the driving controller is configured to alter a voltage level of the third ground voltage within a range during a single frame section in which the plurality of driving stages sequentially outputs the plurality of gate signals.

9. The display device of claim 8, wherein the driving controller is configured to gradually alter the voltage level of the third ground voltage from a first reference voltage to a second reference voltage during the single frame section.

10. The display device of claim 8, wherein the driving controller is configured to gradually lower the voltage level of the third ground voltage from an upper limit reference voltage to a lower limit reference voltage during the single frame section, when the gate signals are sequentially output in order from a driving stage nearest to the driving controller to a driving stage farthest from the driving controller.

11. The display device of claim 8, wherein the driving controller is configured to gradually raise the voltage level of the third ground voltage from a lower limit reference voltage to an upper limit reference voltage during the single frame section, when the gate signals are sequentially output in order from a driving stage farthest from the driving controller to a driving stage nearest to the driving controller.

12. The display device of claim 8, wherein the k-th driving stage of the plurality of driving stages further comprises a second pull-down circuit configured to discharge the k-th carry signal to the second ground voltage in response to the (k+1)-th carry signal.

13. The display device of claim 8, wherein the first pull-down circuit comprises a first electrode connected to a carry terminal providing the k-th gate signal, a second electrode connected to a ground terminal providing the third ground voltage, and a control electrode connected to the (k+1)-th carry signal.

14. The display device of claim 8, wherein the k-th driving stage of the plurality of driving stages further comprises:
a controller configured to provide one of the clock signal and the second ground voltage to a first node in response to the (k−1)-th carry signal and the (k+1)-th carry signal; and
a first output circuit configured to output the clock signal to the k-th gate signal in response to a signal from the first node.

15. The display device of claim 14, wherein the k-th driving stage of the plurality of driving stages further comprises a second output circuit configured to output the clock signal to the k-th carry signal in response to the signal from the first node.

16. The display device of claim 14, wherein the k-th driving stage of the plurality of driving stages further comprises:
an inverter configured to provide the clock signal to a second node;
a first discharge circuit configured to discharge the first node to the second ground voltage in response to a signal from the second node, and to discharge the second node to the second ground voltage in response to the (k−1)-th carry signal;
a second discharge circuit configured to discharge the k-th carry signal to the second ground voltage in response to the signal from the second node; and
a third discharge circuit configured to discharge the k-th gate signal to the first ground voltage in response to the signal from the second node.

17. The display device of claim 8, wherein the display panel comprises:
a display area in which the plurality of pixels are arranged; and
a non-display area adjacent to the display area,
wherein the gate driving circuit is integrated into the non-display area.

18. The display device of claim 8, wherein a voltage level of the second ground voltage is lower than a voltage level of the first ground voltage.

19. The display device of claim 18, wherein the driving controller is configured to gradually lower a voltage level of the third ground voltage, from the first reference voltage between the first ground voltage and the second ground voltage, to the second reference voltage lower than the second ground voltage during the single frame section.
